(19) United States
(12) Patent Application Publication
(10) Pub. No.: US 2020/0341480 A1
(43) Pub. Date: Oct. 29, 2020

(54) OPERATION METHOD OF MOVING ROBOT

(71) Applicant: LG ELECTRONICS INC., Seoul (KR)

(72) Inventor: Jaesik JUNG, Seoul (KR)

(73) Assignee: LG ELECTRONICS INC., Seoul (KR)

(21) Appl. No.: 16/490,497

(22) PCT Filed: Nov. 19, 2018
(86) PCT No.: PCT/KR2018/014174

§ 371 Date: Aug. 30, 2019

(30) Foreign Application Priority Data
Jan. 22, 2018 (KR) 10-2018-0007774
Jan. 22, 2018 (KR) 10-2018-0007775

(51) Int. Cl. G05D 1/02; G05B 19/4155

(52) U.S. Cl. CPC G05D 1/0223; G06F 3/0482; G05B 19/4155

(57) ABSTRACT

A method of operating a moving robot including: determining whether a person exists within a preset first distance; reducing a movement speed, when a person exists within the first distance; determining whether a person exists within a second distance set to be shorter than the first distance; stopping a movement, when a person exists within the second distance; receiving a language selection input; and displaying a menu screen based on a language corresponding to the language selection input, thereby inducing the use of the service and improving user convenience.

### TECHNICAL FIELD

The present invention relates to a moving robot and an operation method of the same, and more particularly, to a moving robot capable of providing a guide and various services to people in public places, and an operation method of the same.

### BACKGROUND ART

In public places such as airport, railway station, harbor, department store, and theater, information is provided to users through electronic display board, indicator board, and the like. However, the electronic display board, the indicator board, and the like transmit only some information selected by a service provider unilaterally, and can not meet the demands of individual users.

Meanwhile, in recent years, the introduction of kiosks for providing information and services to users using multimedia devices such as display means, touch screens, speakers, and the like is increasing. However, even in this case, since the user has to manipulate the kiosk directly, there is a problem that a user who has difficulty in using a device is inconvenient to use and can not actively respond to the request of the user.

Meanwhile, robots have been developed for industrial use and have been part of factory automation. In recent years, the application field of robots has been expanded, and thus, medical robots, aerospace robots, and the like have been developed, and household robots that can be used in ordinary homes have been manufactured.

Therefore, research on ways to provide various services such as guide and advertisement in public places using robots is increasing.

Meanwhile, the moving robot is capable of moving by itself, is free to move, and has a plurality of means for avoiding obstacles during traveling, so that it can travel while avoiding obstacles and cliffs.

For example, Korean Patent Laid-Open Publication No. 10-2013-0141979 discloses a moving robot having a light source unit for irradiating light in a cross pattern and a camera unit for acquiring a forward image.

An infrared sensor or an ultrasonic sensor may be used for detecting an obstacle of the moving robot. The moving robot determines the presence and distance of the obstacle through the infrared sensor, and the ultrasonic sensor emits an ultrasonic wave having a certain cycle. Then, if there is an ultrasonic wave reflected by the obstacle, the ultrasonic sensor can determine the distance to the obstacle by using a time difference between a time when the ultrasonic wave is emitted and a moment when the ultrasonic wave is returned as being reflected by the obstacle.

### DISCLOSURE

### Technical Problem

A moving robot operated in public places such as airports, railway stations, department stores, and ports where many people stay or move can recognize people and obstacles, and can autonomously travel and provide various services.

Accordingly, there is a need for a method of identifying the intentions of a nearby person or a specific user or inducing a use of the nearby person or the specific user, during the autonomous traveling of moving robot, as well as a method of automatically traveling while the mobile robot recognizes people and obstacles to ensure safety

In addition, there is a need for a method of easily identifying the traveling and operation state of moving robot in order to ensure people's safety in a public place, as well as a method of automatically traveling while the mobile robot recognizes people and obstacles to secure safety.

An object of the present invention is to provide a moving robot and an operation method of the same that can provide various services, such as a guide service in a public place.

An object of the present invention is to provide a moving robot and an operation method of the same that can easily provide information displayed on a display during a service providing process, such as road guide.

An object of the present invention is to provide a moving robot and an operation method of the same that can improve the efficiency and user convenience of the information providing method by utilizing two displays in various manners depending on the type of information, the amount of information, the interaction distance between the robot and the user, and the size of the display.

An object of the present invention is to provide a moving robot that can be safely operated in a public place and an operation method of the same.

An object of the present invention is to provide a moving robot and an operation method of the same that can reduce the risk of accidents of people and the moving robot by allowing people to easily determine the operation state of the moving robot.

### Technical Solution

In order to achieve the above or another object, a method of operating a moving robot according to an aspect of the present invention includes: determining whether a person exists within a preset first distance; reducing a movement speed, when a person exists within the first distance; determining whether a person exists within a second distance set to be shorter than the first distance; stopping a movement, when a person exists within the second distance; receiving a language selection input; and displaying a menu screen based on a language corresponding to the language selection input.

In order to achieve the above or another object, method of operating a moving robot according to an aspect of the present invention further includes emitting light by emitting modules, based on the current state of the mobile robot, thereby easily determining the operating state of the mobile robot and operating safely in public places.

### Advantageous Effects

According to at least one of the embodiments of the present invention, it is possible to provide various services, such as a guide service in a public place.

In addition, according to at least one of the embodiments of the present invention, it is possible to easily provide information displayed on a display in the process of providing a service such as a road guide.

In addition, according to at least one of the embodiments of the present invention, it is possible to improve the efficiency and user convenience of the information providing method by utilizing two displays in various manners depending on the type of information, the amount of information, the interaction distance between the robot and the user, and the size of the display.

In addition, according to at least one of the embodiments of the present invention, it is possible to provide a moving robot that can be safely operated in a public place and an operation method of the same.

In addition, according to at least one of the embodiments of the present invention, it is possible to provide a moving robot and an operation method of the same that can reduce the risk of accidents of people and the moving robot by allowing people to easily determine the traveling state of the moving robot.

Meanwhile, various other effects will be disclosed directly or implicitly in the detailed description according to the embodiment of the present invention described later.

### DESCRIPTION OF DRAWINGS

FIG. 1 is a perspective view of a moving robot according to an embodiment of the present invention.

FIG. 2 is a bottom perspective view of a moving robot viewed from below according to an embodiment of the present invention.

FIG. 3 is a side view of a moving robot according to an embodiment of the present invention.

FIG. 4 is a view illustrating arrangement of displays of a moving robot according to an embodiment of the present invention.

FIG. 5 is a block diagram illustrating a control relationship between main components of a moving robot according to an embodiment of the present invention.

FIG. 6 is a flowchart illustrating an operation method of a moving robot according to an embodiment of the present invention.

FIG. 7 is a view for explaining a standby traveling of a moving robot according to an embodiment of the present invention.

FIG. 8 is a view for explaining a user detection distance of a moving robot and an operation for each zone according to an embodiment of the present invention.

FIG. 9 is a flowchart illustrating a method of operating a moving robot according to an embodiment of the present invention.

FIGS. 10 to 12 are views for explaining an operation method of a moving robot according to an embodiment of the present invention.

FIGS. 13 to 20 are views for explaining an operation method of a moving robot according to an embodiment of the present invention.

### MODE FOR INVENTION

Hereinafter, the embodiments disclosed in the present specification will be described in detail with reference to the accompanying drawings, and the same or similar elements are denoted by the same reference numerals even though they are depicted in different drawings and redundant descriptions thereof will be omitted. In the following description, with respect to constituent elements used in the following description, the suffixes “module” and “unit” are used or combined with each other only in consideration of ease in the preparation of the specification, and do not have or serve as different meanings. Accordingly, the suffixes “module” and “unit” may be interchanged with each other.

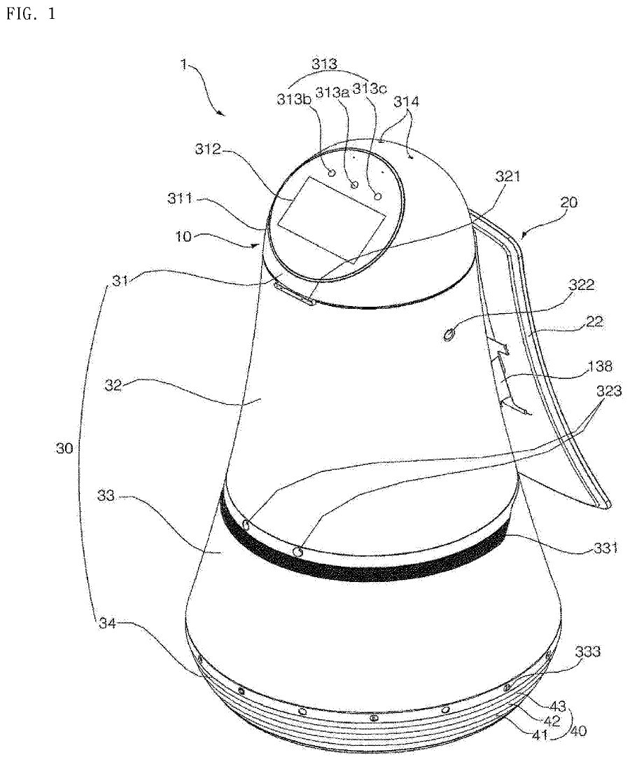

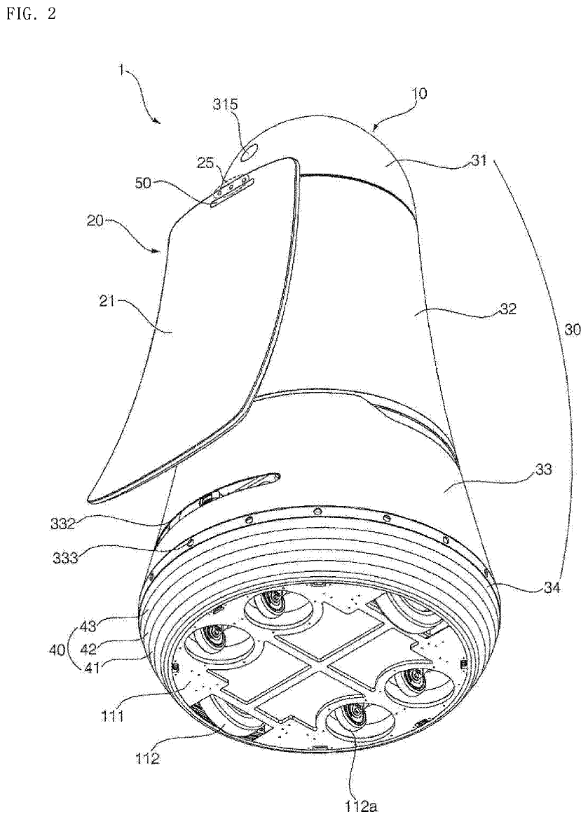

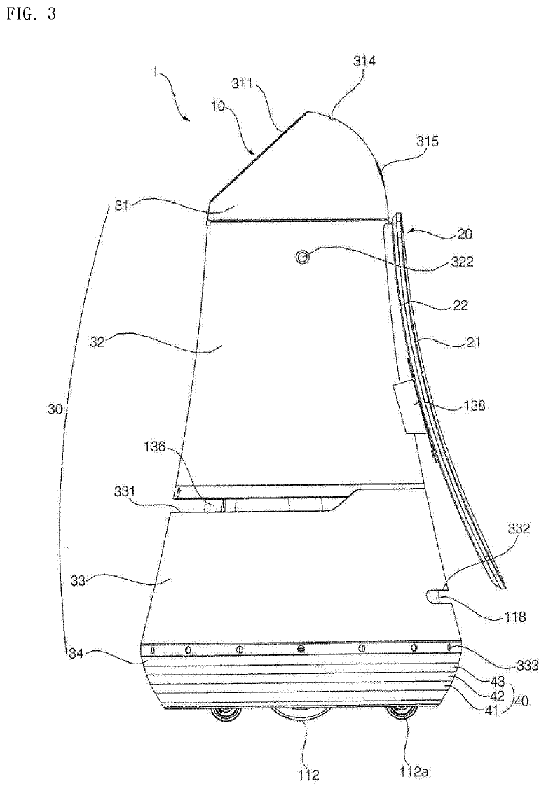

FIG. 1 is a perspective view of a moving robot according to an embodiment of the present invention, FIG. 2 is a bottom perspective view of a moving robot viewed from below according to an embodiment of the present invention, and FIG. 3 is a side view of a moving robot according to an embodiment of the present invention.

Referring to FIGS. 1 to 3, a moving robot 1 according to an embodiment of the present invention may include a main body that forms an outer appearance and houses various components therein.

The main body 10 may have a long length in a vertical direction, and may have a roly poly shape that becomes slender as it goes up from the lower part to the upper part.

The main body 10 may include a case 30 forming an outer appearance of the moving robot 1. The case 30 may include a top cover 31 disposed in the upper side, a first middle cover 32 disposed below the top cover 31, a second middle cover 33 disposed below the first middle cover 32, and a bottom cover 34 disposed below the second middle cover 33. Here, the first middle cover 32 and the second middle cover 33 may be implemented by the same middle cover.

The top cover 31 is positioned in the uppermost end of the moving robot 1, and may have a hemispherical shape or a dome shape. The top cover 31 may be positioned at a lower height than adult's height so as to easily receive a command from a user. The top cover 31 may be configured to rotate at a certain angle.

Meanwhile, the top cover 31 is disposed in the uppermost end of the moving robot 1, and houses various components therein, and may have a shape and function similar to those of a human head and accomplish interaction with the user. Therefore, the top cover 31 and the components disposed therein may be referred to as a head. Further, the configuration of the components housed inside the top cover 31 or disposed outside the top cover 31 may be referred to as a head unit. Meanwhile, the remaining portion disposed below the head may be referred to as a body.

The top cover 31 may include an operation unit 311 in one side of a front surface. The operation unit 311 may serve to receive a command from a user. To this end, the operation unit 311 may include a display 312 for receiving a touch input from a user.

The display 312 disposed in the operation unit 311 may be referred to as a first display or a head display 312, and the display included in a display unit 20 disposed in the body may be referred to as a second display or a body display 21.

The head display 312 may form a mutual layer structure with a touch pad to implement a touch screen. In this case, the head display 312 may be used as an input device for inputting information by a user's touch as well as an output device.

In addition, the operation unit 311 may be directed upward by a certain angle so that user can easily operate while viewing the head display 312 downward. For example, the operation unit 311 may be disposed on a surface which is formed by cutting a part of the top cover 31. Accordingly, the head display 312 may be disposed to be inclined.

In addition, the operation unit 311 may have a circular or elliptical shape as a whole. The operation unit 311 may be implemented in a manner similar to a human face shape.

For example, the operation unit 311 has a circular shape, and one or more structures for expressing the eyes, nose, mouth, eyebrows, or the like of a human may be positioned on the operation unit 311.

That is, on the operation unit 311, a specific structure may be disposed or a specific paint may be painted to express the eyes, nose, mouth, eyebrows, or the like of a human. Therefore, the operation unit 311 has a human face shape, thereby providing a user with an emotional feeling. Furthermore, when a robot having a human face shape travels, it is possible to give a feeling that a person is moving, thereby relieving the repulsion toward a robot.

As another example, one or more images for expressing the eyes, nose, mouth, eyebrows, or the like of a human may be displayed on the head display 312.

That is, on the head display 312, not only information related to a route guide service but also various images for expressing the human face shape may be displayed. On the head display 312, an image for expressing a facial expression determined at a given time interval or at a specific time may be displayed.

Meanwhile, referring to FIG. 1, the direction in which the body display 21 faces is defined as “rear ward”, and the opposite direction of “rear ward” is defined as “forward”.

In addition, the operation unit 311 may be provided with a head camera unit 313 for recognizing people and objects.

The head camera unit 313 may be disposed in the upper side of the head display 312. The head camera unit 313 may include a 2D camera 313a and a RGBD sensor 313b, 313c.

The 2D camera 313a may be a sensor for recognizing a person or an object based on a two-dimensional image.

In addition, the RGBD sensor (Red, Green, Blue, Distance) 313b, 313c may be a sensor for acquiring a person's position or a face image. The RGBD sensor 313b, 313c may be a sensor for detecting a person or an object by using captured images having depth data acquired from a camera having RGBD sensors or from other similar 3D imaging device.

In order to accurately detect a person's position or a face image, a plurality of RGBD sensors 313b and 313c may be provided. For example, two RGBD sensors 313b, 313c may be disposed in the left and right sides of the 2D camera 313a.

The head camera unit 313 may be configured of a 3D vision sensor such as an RGBD camera sensor. The head camera unit 313 may sense a existence of a person within a certain distance, the existence of a guide object in a guide mode, a distance between a person and the moving robot 1, the moving speed of a person, or the like.

Meanwhile, although not shown, the operation unit 311 may further include a physical button for directly receiving a command from a user.

In addition, the top cover 31 may further include a microphone 314.

The microphone 314 may serve to receive a command of an audio signal from a user. For example, the microphone 314 may be formed at four points at any point on the upper end portion of the top cover 31 to accurately receive the voice command from the user. Therefore, even when the moving robot 1 is traveling or the top cover 31 is rotating, the route guide request from the user can be accurately received.

In an embodiment of the present invention, the top cover 31 may be rotated so that the operation unit 311 is oriented to the traveling direction while the moving robot 1 is traveling. When the moving robot 1 receives a command (e.g., voice command) from the user while the moving robot 1 is traveling, the top cover 31 may be rotated so that the operation unit 311 is oriented to the direction in which the user is positioned.

Alternatively, when the moving robot 1 receives a command from the user while the moving robot 1 is traveling, the top cover 31 may be rotated in a direction opposite to the traveling direction of the moving robot 1. That is, the top cover 31 may be rotated in a direction that the body display unit 20 faces. Accordingly, the user may operate the operation unit 311 effectively while viewing guide service information or the like displayed on the body display unit 20.

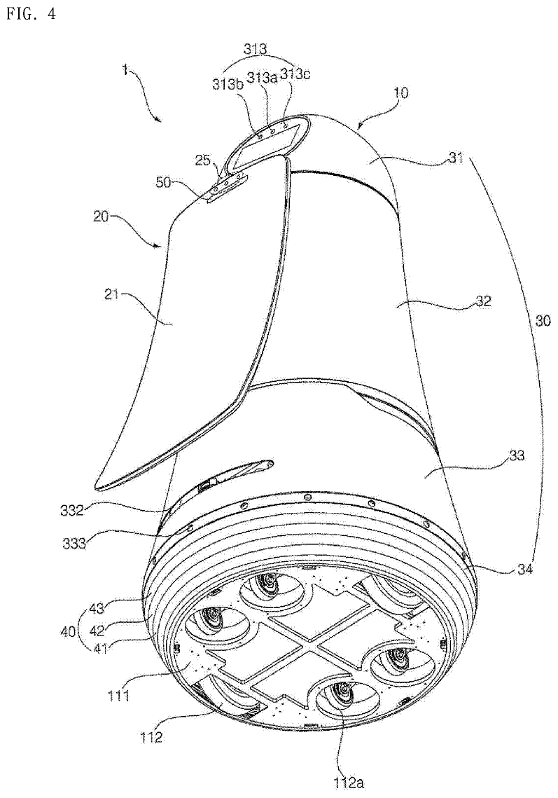

FIG. 4 is a view illustrating arrangement of the displays of the moving robot 1 according to an embodiment of the present invention.

Referring to FIG. 4, when the moving robot 1 receives a command from the user in an interaction state or is in a standby state, the displays 312 and 20 may be disposed in one direction, so that a user or users of public places can more easily view the information displayed on the two displays 312, 20.

The interaction state may correspond to a case where the moving robot 1 provides a voice guide, a menu screen, or the like to a certain user, receives a touch, voice input from the user, or is providing a guide service.

Meanwhile, the viewing directions of the operation unit 311 and the body display unit 20 may be opposite to each other. In this case, for example, the operation unit 311 may be oriented toward one direction, and the display unit 20 may be oriented toward the other direction opposite to the one direction. Therefore, there is an advantage in that the information displayed on the operation unit 311 or the body display unit 20 can be viewed from both directions.

Preferably, in a state where the moving robot 1 is traveling or stopped, the directions viewed by the operation unit 311 and the body display unit 20 may be different from each other when the moving robot 1 is traveling or stopped.

For example, when the moving robot 1 is traveling, as illustrated in FIG. 1, the directions viewed by the operation unit 311 and the body display unit 20 may be opposite to each other.

In addition, when the moving robot 1 is in a standby state, as illustrated in FIG. 4, the directions viewed by the operation unit 311 and the body display unit 20 may be the same

In addition, the top cover 31 may further include an emergency operation button 315. The emergency operation button 315 may serve to immediately stop the operation of the moving robot 1 while the moving robot 1 is stopped or traveling. For example, the emergency operation button 315 may be positioned in the rear side of the moving robot 1 so that the emergency operation button 315 can be operated easily, even if the moving robot 1 travels forward.

The first middle cover 32 may be disposed below the top cover 31. Various electronic components including a substrate may be positioned inside the first middle cover 33. The first middle cover 32 may have a cylindrical shape having a larger diameter as it goes downward from the upper portion.

More preferably, the first middle cover 32 may include an RGBD sensor 321.

The RGBD sensor 321 may detect a collision between the moving robot 1 and an obstacle while the moving robot 1 is traveling. For this purpose, the RGBD sensor 321 may be positioned in a direction in which the moving robot 1 travels, that is, in the front side of the first middle cover 32.

For example, the RGBD sensor 321 may be positioned in the upper end of the first middle cover 32, taking into account the obstacle or human height present in front of the moving robot 1.

However, the present invention is not limited thereto, and the RGBD sensor 321 may be disposed in various positions in the front side of the first middle cover 32.

According to an embodiment, the RGBD sensor 321 may be constituted by a 3D vision sensor, and may sense a existence of a person within a certain distance, a existence of a guide object in a guide mode, a distance between a person and the moving robot 1, the moving speed of a person, or the like.

In some embodiments, the RGBD sensor 321 may not be disposed in the first middle cover 32 and the function of the RGBD sensor 321 may be performed in the head camera unit 313.

In addition, the first middle cover 32 may further include a speaker hole 322.

The speaker hole 322 may be a hole for transmitting sound generated from the speaker to the outside. The speaker hole 322 may be formed on the outer peripheral surface of the first middle cover 32, and a single speaker hole may be formed. Alternatively, a plurality of speaker holes 322 may be formed on the outer peripheral surface of the first middle cover 32 to be spaced apart from each other.

In addition, the first middle cover 32 may further include a stereo camera hole 323.

The stereo camera hole 323 may be a hole for operation of a stereo camera (not shown) installed inside the main body 10. For example, the stereo camera hole 323 may be formed in a lower front end of the first middle cover 32. Accordingly, the stereo camera may photograph the front area of the moving robot 1 through the stereo camera hole 323.

The second middle cover 33 may be disposed below the first middle cover 32. A battery, a lidar for autonomous driving, and the like may be positioned inside the second middle cover 33. Like the first middle cover 32, the second middle cover 33 may have a cylindrical shape that has a larger diameter as they progress from the upper portion to the lower portion. The outer side of the second middle cover 33 may be connected to the outer side of the first middle cover 32 without a step. That is, since the outer side of the second middle cover 33 and the outer side of the first middle cover 32 can be smoothly connected, the outer appearance of may be seen beautiful.

Further, since the first middle cover 32 and the second middle cover 33 have a cylindrical shape that has a larger diameter as they progress from the upper portion to the lower portion, the overall shape may be a roly-poly shape. Therefore, the impact generated when the main body 10 collides with a person or an obstacle can be alleviated.

In detail, the second middle cover 33 may include a first incision portion 331.

The first incision portion 331 may be formed laterally in the front side of the outer peripheral surface of the second middle cover 33. The first incision portion 331 is a portion cut from the second middle cover 33 so that a front lidar 136, which will be described later, can be operated.

Specifically, the first incision portion 331 may be cut by a certain length in the radial direction from the outer peripheral surface of the front side of the second middle cover 33. Here, the front lidar 136 is positioned inside the second middle cover 33. The first incision portion 331 may be formed by being cut along the circumference of the second middle cover 33 on the outer peripheral surface of the second middle cover 33 corresponding to the position of the front lidar 136. That is, the first incision portion 331 and the front lidar 136 may face each other. Therefore, the front lidar 136 may be exposed to the outside by the first incision portion 331.

For example, the first incision portion 331 may be cut by 270 degrees around the front side of the second middle cover 33. The reason that the first incision portion 331 should be formed in the second middle cover 33 is to prevent the laser emitted from the front lidar 136 from being directly irradiated to the eyes of an adult or a child.

In addition, the second middle cover 33 may further include a second incision portion 332.

The second incision portion 332 may be formed laterally in the rear side of the outer peripheral surface of the second middle cover 33. The second incision portion 332 is a portion cut from the second middle cover 33 so that a rear lidar 118, which will be described later, can be operated.

Specifically, the second incision portion 332 may be cut by a certain length in the radial direction from the outer peripheral surface of the rear side of the second middle cover 33. Here, the rear lidar 118 is positioned inside the second middle cover 33. The second incision portion 332 may be formed by being cut along the circumference of the second middle cover 33 at a position corresponding to the position of the rear lidar 118. Therefore, the rear lidar 118 may be exposed to the outside by the second incision portion 332. For example, the second incision 332 may be cut by 130 degrees along the circumference in the rear side of the second middle cover 33.

In the present embodiment, the first incision portion 331 may be spaced apart from the second incision portion 332 in the vertical direction so that the first incision portion 331 and the second incision portion 332 are not connected. The first incision portion 331 may be positioned above the second incision portion 332.

If the first incision portion 331 and the second incision 332 are positioned in the same line, the laser emitted from the lidar of one moving robot may be irradiated to the lidar of the other moving robot. Then, the lasers emitted from the lidars of the respective moving robots may interfere with each other, and thus, accurate distance detection may become difficult. In this case, it is impossible to detect the distance between the moving robot and the obstacle, normal traveling is difficult and a problem that the moving robot and the obstacle collide with each other may occur.

Further, the second middle cover 33 may further include an ultrasonic sensor 333.

The ultrasonic sensor 333 may be a sensor for measuring the distance between the obstacle and the moving robot 1 by using an ultrasonic signal. The ultrasonic sensor 333 may serve to detect an obstacle close to the moving robot 1.

For example, a plurality of ultrasonic sensors 333 may be provided to detect obstacles in all directions close to the moving robot 1. The plurality of ultrasonic sensors 333 may be disposed to be spaced apart from each other around the lower end of the second middle cover 33.

The bottom cover 34 may be disposed below the second middle cover 33. A wheel 112, a caster 112a, and the like may be positioned inside the bottom cover. Unlike the first middle cover 32 and the second middle cover 33, the bottom cover 34 may have a cylindrical shape whose diameter decreases as it progresses from the upper portion to the lower portion. That is, the main body 10 has a roly-poly shape as a whole to reduce the amount of impact applied when the robot is in a collision state, and the lower end of the main body 10 has a structure of becoming narrow inwardly to prevent a human foot from being caught by the wheels of the robot.

In detail, a base 111 may be positioned inside the bottom cover 34.

The base 111 may form a bottom surface of the moving robot 1.

The base 111 may be provided with a wheel 112 for traveling of the moving robot 1. The wheel 112 may be positioned in the left and right sides of the base 111, respectively.

In addition, the base 111 may be provided with a caster 112a for assisting the traveling of the moving robot 1. Here, the caster 112a may be constituted of a plurality of casters for manual movement of the moving robot 1. For example, two casters 112a may be positioned in the front portion of the base 111, and two casters 112a may be positioned in the rear portion of the base 111, respectively.

According to the above-described caster structure, when the power of the moving robot 1 is turned off or the moving robot 1 is to be manually moved, there is an advantage that the moving robot 1 can be pushed and moved without applying a large force.

The bottom cover 34 may be provided with light emitting modules 40 that include one or more light emitting diodes (LEDs) respectively, and at least one of the light emitting modules 40 may be turned on or off according to the operation state of the moving robot. For example, at least one of the light emitting modules 40 may output light of a certain color or may blink at certain cycles according to the operation state of the moving robot. In addition, two or more light emitting modules among the light emitting modules 40 may output light in a certain pattern according to the operation state of the moving robot.

The light emitting modules 40 may include one or more light emitting diodes as a light source respectively. When a plurality of light sources are provided, the plurality of light sources may be disposed with a constant pitch for uniform light supply. The number of light sources and the pitch may be set in consideration of the light intensity. Further, all the colors of the plurality of light sources may be white, or the colors of adjacent light sources may be mixed to emit white light.

The light source may be an aggregate in which a plurality of light emitting diodes are disposed close to each other, as well as a single light emitting diode. In addition, it is also possible to include, for example, a case in which red, blue, and green light emitting diodes, which are three primary colors of light, are disposed close to each other.

Preferably, the light emitting modules 40 may be disposed along the periphery of the bottom cover 34. For example, the light emitting modules 40 may be disposed on any circle that surrounds the periphery of the bottom cover 34 in the horizontal direction.

The light emitting modules 40 may be disposed in the bottom cover 34, which is the lower end of the moving robot 1, so that the light emitting modules 40 may be disposed in a position considerably lower than a human eye level. Accordingly, when the light emitting modules 40 continuously output or blink a specific light, people can feel less glare.

The light emitting modules 40 are disposed to surround the bottom cover 34 in the horizontal direction so that people can see light emitted from the light emitting modules 40 in any direction of 360 degrees.

The light emitting modules 40 are disposed in the bottom cover 34 to be spaced apart from the body display 21 of a large screen which displays a certain image. Accordingly, it is possible to prevent the output light of the light emitting modules 40 and the output image of the body display 21 from deteriorating visibility of each other.

In addition, the light emitting modules 40 may have a plurality of rows and may be disposed in multiple stages. Accordingly, visibility of light outputted by the light emitting modules 40 can be further increased.

For example, the light emitting modules 40 may be disposed in three rows 41, 42, and 43 having different lengths. In this case, the length of the row 41 positioned in the lowermost end of the three rows 41, 42, and 43 may be the shortest.

More preferably, the light emitting modules 40 may be disposed to have a plurality of rows and columns. For example, the light emitting modules 40 may be disposed in three rows 41, 42 and 43, and each row 41, 42 and 43 may include a plurality of light emitting modules which are independently controllable. Accordingly, the light emitting modules 40 may have a plurality of rows and columns, and when the entire light emitting modules 40 are unfolded, they may be disposed in the form of a matrix of M*N.

The body display unit 20 may be formed long in the vertical direction in one side of the moving robot 1.

In detail, the body display unit 20 may include the body display 21 and a support portion 22.

The body display 21 may be positioned in the rear side of the first middle cover 32. The body display 21 may serve to output time information (e.g., airport gate inquiry information, route guide service information, etc.) related to a service currently being provided.

In addition, the body display 21 may be a curved surface display having a shape curved outward with a certain curvature. That is, the body display 21 may have a concave shape as a whole. The body display 21 may have a shape that is more tilted backward as it goes down from the upper portion to the lower portion. In other words, the body display 21 may be formed to gradually go further away from the case 30 as it goes down from the upper portion to the lower portion.

According to the display unit structure described above, there is an advantage in that not only the information displayed on the body display 21 is visible in a position far from the moving robot 1 but also the information displayed on the body display 21 is not distorted at various angles.

In addition, according to an embodiment of the present invention, the moving robot 1 may move ahead along a set route to guide the user to the route. The user can see the body display unit 20 installed in the rear side of the moving robot 1 while following the moving robot 1. That is, even if the moving robot 1 travels for guiding the route, the user can easily see the information displayed on the body display unit 20 while following the moving robot 1.

In addition, the upper end of the body display 21 may extend to the upper end of the first middle cover 32 and the lower end of the body display 21 may extend to the second incision portion 332. In this embodiment, the lower end of the body display 21 should be formed not to exceed the second incision portion 332. If the body display 21 is formed to cover the second incision portion 332, the laser emitted from the rear lidar 118 is struck against the lower end of the body display 21. Accordingly, the moving robot 1 may not be able to detect the distance to the obstacle positioned behind.

Meanwhile, the support portion 22 may serve to hold the body display 21 to be positioned in the rear side of the first middle cover 32. The support portion 22 may extend from the rear surface of the body display portion 21. The support portion 22 may be formed to be long in the vertical direction in the rear surface of the body display 21, and may protrude further while progressing downward from the upper portion to the lower portion.

In addition, the support portion 22 may be inserted into the first middle cover 32 through the rear side of the first middle cover 32. For this, a through hole (not shown) through which the support portion 22 can pass through may be formed in the rear of the first middle cover 32. The through-hole may be formed by cutting a part of the rear side of the outer peripheral surface of the first middle cover 32 rearward.

The body display unit 20 may be fixed to the inside of the main body 10 by a separate fixing member 138.

The fixing member 138 for fixing the body display unit 20 to the main body 10 may be provided inside the main body 10. One side of the fixing member 138 may be fixed to the main body 10 and the other side of the fixing member 138 may be fixed to the body display unit 20. To this end, the other side of the fixing member 138 may protrude to the outside of the case 30 through the through hole. That is, the support portion 22 and the fixing member 138 may be positioned together in the through-hole.

In the present embodiment, the body display unit 20 may be fastened to the fixing member 138 by fastening means. At this time, the support portion 22 of the body display unit 20 may be placed on the upper portion of the fixing member 138. In other words, the support portion 22 may be placed on the upper portion of the fixing member 138, and a part of the fixing member 138 may be fixed to a part of the body display unit 20. With such a display unit fixing structure, the body display unit 20 can be stably positioned in the rear side of the first middle cover 32.

In addition, the body display unit 20 may further include a ticket input port 50. The present embodiment illustrates that the ticket input port 50 is disposed in the body display unit 20, but the present invention is not limited thereto, and the ticket input port 50 may be disposed in other portion of the moving robot 1.

According to an embodiment of the present invention, the moving robot 1 may scan a barcode, a QR code, and the like contained in the ticket, when a ticket such as an air ticket is inserted into the ticket input port 50.

In addition, the moving robot 1 may display a scan result on the body display 21, and provide a user with gate information, counter information, etc. according to the scan result.

Meanwhile, the body display unit 20 may further include a body camera unit 25 for identifying and tracking the guide object.

The body camera unit 25 may be constituted of a 3D vision sensor such as an RGBD camera sensor. The body camera unit 25 may sense the existence of a person within a certain distance, the existence of a guide object in a guide mode, distance between a person and the moving robot 1, the moving speed of a person, and the like.

In some embodiments, the moving robot 1 may not include the body camera unit 25, but may further include a sensor for identifying and tracking guide object disposed in other area.

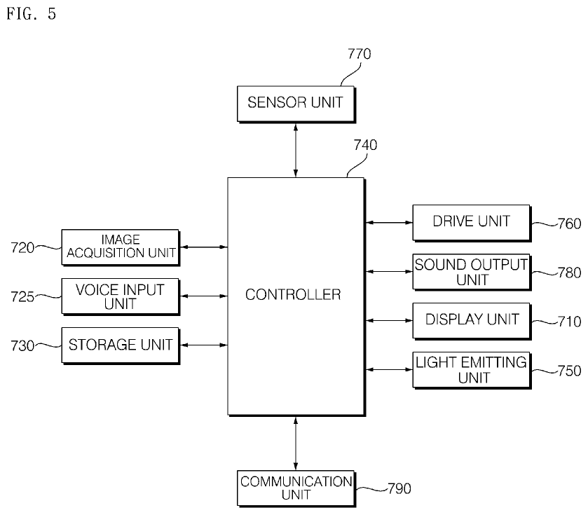

FIG. 5 is a block diagram illustrating a control relationship between main components of a moving robot according to an embodiment of the present invention.

Referring to FIG. 5, the moving robot 1 according to an embodiment of the present invention may include a voice input unit 725 for receiving a user's voice input through the microphone 314, a storage unit 730 for storing various data, a communication unit 790 for transmitting/receiving data to/from other electronic device such as a server (not shown), a light emitting unit 750 including at least one light emitting module for outputting light to the outside, and a controller 740 for controlling the overall operation of the moving robot 1.

The voice input unit 725 may include a processing unit for converting an analog sound into digital data or may be connected to the processing unit, thereby converting a user input voice signal into data to be recognized by the controller 740 or a server (not shown).

The controller 740 may control the voice input unit 725, the storage unit 730, the light emitting unit 750, the communication unit 790, and the like constituting the moving robot 1 to control the overall operation of the moving robot 1.

The storage unit 730 records various types of information necessary for controlling the moving robot 1, and may include a volatile or nonvolatile recording medium. The recording medium stores data that can be read by a microprocessor, and includes a hard disk drive (HDD), a solid state disk (SSD), a silicon disk drive (SDD), a ROM, a RAM, a CD-ROM, a magnetic tape, a floppy disk, an optical data storage device, and the like.

In addition, the storage unit 730 may store various data necessary for the moving robot 1 to provide a guide service.

In addition, the controller 740 may transmit the operation state of the moving robot 1, the user input, or the like to the server through the communication unit 790.

The communication unit 790 includes at least one communication module so that the moving robot 1 is connected to the Internet or a certain network.

Meanwhile, data for voice recognition may be stored in the storage unit 730, and the controller 740 may process a voice input signal of user received through the voice input unit 725 and perform a voice recognition process.

Meanwhile, the controller 740 may control the moving robot 1 to perform a certain operation based on the voice recognition result.

For example, when the command included in the voice signal is a command for requesting certain information such as flight start information, sightseeing guide information, and the like, the controller 740 may control to display certain information such as flight start information and sightseeing guide information on the display unit 710.

In addition, if there is a user's guide request, the controller 740 may control to escort a user to a guide destination selected by the user.

Meanwhile, the voice recognition process may be performed in the server, not in the moving robot 1 itself.

In this case, the controller 740 may control the communication unit 790 to transmit the user input voice signal to the server, and may receive the recognition result of the voice signal from the server through the communication unit 790.

Alternatively, the moving robot 1 may perform simple voice recognition such as call word recognition, and high-level voice recognition such as natural language processing may be performed in the server.

Meanwhile, the moving robot 1 may include a display unit 710 for displaying certain information as an image and a sound output unit 780 for outputting certain information as a sound.

The display unit 710 may display information corresponding to a request input by a user, a processing result corresponding to a request input by the user, an operation mode, an operation state, an error state, and the like as an image.

As described above with reference to FIGS. 1 to 4, the display unit 710 may include a head display 312 and a body display 21. Since the body display 21 is relatively larger in size than the head display 312, it may be preferable to display information on the body display 21 in a large screen.

In addition, the sound output unit 780 may output a notification message such as an alarm sound, an operation mode, an operation state, and an error state, information corresponding to a request input by the user, a processing result corresponding to a request input by the user, and the like. The sound output unit 780 may convert an electrical signal from the controller 740 into an audio signal and output the audio signal. For this purpose, a speaker or the like may be provided.

Meanwhile, the moving robot 1 may include an image acquisition unit 720 for photographing a certain range.

The image acquisition unit 720 photographs the surroundings of the moving robot 1, the external environment, and the like, and may include a camera module. Several cameras may be installed for each part of the moving robot for photographing efficiency.

For example, as described above with reference to FIGS. 1 to 4, the image acquisition unit 720 may include a head camera unit 313 for recognizing a person and an object, and a body camera unit 25 for identifying and tracking the guide object. However, the number, arrangement, type, and photographing range of the cameras included in the image acquisition unit 720 are not necessarily limited thereto.

The image acquisition unit 720 may photograph an image for user recognition. The controller 740 may determine an external situation or recognize a user (guide object), based on the image photographed and acquired by the image acquisition unit 720.

In addition, the controller 740 may control the moving robot 1 to travel, based on the image photographed and acquired by the image acquisition unit 720.

Meanwhile, the image photographed and acquired by the image acquisition unit 720 may be stored in the storage unit 730.

Meanwhile, the moving robot 1 may include a drive unit 760 for moving, and the drive unit 760 may move the main body 10 under the control of the controller 740.

The drive unit 760 may include at least one drive wheel 112 for moving the main body 10 of the moving robot 1. The drive unit 760 may include a drive motor (not shown) connected to the drive wheel 112 to rotate the drive wheel. The drive wheel 112 may be provided in the left and right sides of the main body 10, respectively, and may be referred to as left and right wheels, respectively.

The left wheel and the right wheel may be driven by a single drive motor, but may be provided with a left wheel drive motor for driving the left wheel and a right wheel drive motor for driving the right wheel, respectively, if necessary. The traveling direction of the main body 10 may be switched to the left or right side by making a difference in the rotational speeds of the left and right wheels.

Meanwhile, the moving robot 1 may include a sensor unit 770 including sensors for sensing various data related to the operation and state of the moving robot 1.

The sensor unit 770 may include an obstacle detection sensor that detects an obstacle. The obstacle detection sensor may include an infrared sensor, an ultrasonic sensor, an RF sensor, a geomagnetic sensor, a position sensitive device (PSD) sensor, and the like. For example, the obstacle detection sensor may correspond to the ultrasonic sensor 333, the RGBD sensor 321, and the like described above with reference to FIGS. 1 to 4.

In addition, the sensor unit 770 may further include a cliff sensor 113 for detecting the existence of a cliff on the floor in a traveling area.

In some embodiments, the sensor unit 770 may further include a sensor for detecting a magnitude of a sound acquired through the microphone 314, and accordingly, may sense the magnitude of a voice uttered by the user, and the magnitude of ambient noise.

Alternatively, without further including a separate sensor, the voice input unit 725 may determine the magnitude of the voice of user and the ambient noise during the processing of a signal acquired through the microphone 314.

In addition, the sensor unit 770 may include a light detection and ranging (Lidar) 136, 118.

The lidar 136, 118 may detect an object such as an obstacle, based on a Time of Flight (TOF) of a transmission signal and a reception signal or a phase difference between a transmission signal and a reception signal, by a medium of a laser light.

Further, the lidar 132a, 132b may detect the distance to the object, the relative speed with the object, and the position of the object.

The lidar 132a, 132b may be provided as part of the configuration of the obstacle detection sensor. Further, the lidar 132a, 132b may be provided as a sensor for creating a map.

Meanwhile, the obstacle detection sensor detects an object, particularly an obstacle, existing in a traveling direction (movement direction) of the moving robot, and transmits obstacle information to the controller 740. At this time, the controller 740 may control the motion of the moving robot 1 according to the position of the detected obstacle.

The sensor unit 770 may further include a motion sensor for detecting motion of the moving robot 1 according to driving of the main body 101 and outputting motion information. For example, a gyro sensor, a wheel sensor, an acceleration sensor, and the like may be used as the motion sensor.

The gyro sensor senses the rotation direction and detects the rotation angle when the moving robot 1 moves according to the operation mode. The gyro sensor detects the angular velocity of the moving robot 1 and outputs a voltage value proportional to the angular velocity. The controller 740 calculates the rotation direction and the rotation angle by using the voltage value outputted from the gyro sensor.

The wheel sensor is connected to the left and right wheels to detect the number of rotations of the wheel. Here, the wheel sensor may be a rotary encoder. The rotary encoder detects and outputs the number of rotations of the left and right wheels.

The controller 740 may calculate the rotational speeds of the left and right wheels by using the number of rotations. In addition, the controller 740 may calculate the rotation angle by using a difference in the number of rotations of the left and right wheels.

The acceleration sensor detects a speed change of the moving robot 1, for example, a change in the moving robot 1 due to a start, a stop, a direction change, a collision with an object, or the like. The acceleration sensor is attached to the adjacent position of the main wheel or the auxiliary wheel, so that the slip or idling of the wheel can be detected.

In addition, the acceleration sensor is built in the controller 740 and may detect a speed change of the moving robot 1. That is, the acceleration sensor detects impulse due to the speed change and outputs a corresponding voltage value. Thus, the acceleration sensor may perform the function of an electronic bumper.

The controller 740 may calculate the position change of the moving robot 1 based on operation information outputted from the motion sensor. Such a position is a relative position corresponding to the absolute position using image information. The moving robot may improve the performance of the position recognition using the image information and the obstacle information through the relative position recognition.

The light emitting unit 750 may include a plurality of light emitting modules. For example, as described with reference to FIGS. 1 to 4, the light emitting unit 750 may include light emitting modules 40 include one or more light emitting diodes (LEDs) respectively.

In addition, the light emitting modules 40 may be disposed in the bottom cover 34, and the light emitting modules 40 may be operated under the control of the controller 740.

For example, the controller 740 may control at least one of the light emitting modules 40 to output light of a certain color or to blink at certain cycles according to the operation state of the moving robot. In addition, the controller 740 may control two or more modules of the light emitting modules 40 to output light in a certain pattern according to the operation state of the moving robot.

As described above with reference to FIGS. 1 to 5, the moving robot 1 according to an embodiment of the present invention may include a top cover 31 provided to be rotatable, a first display 312 disposed in the top cover 31, a second display 21 having a size larger than the first display 312, a middle cover 32, 33 coupled with the second display 21 and the top cover 31, a bottom cover 34 positioned below the middle cover 32, 33, a light emitting unit 750 including light emitting modules 40 disposed along the periphery of the bottom cover 34, and a controller 740 for controlling the light emitting modules 40 based on the current state of the moving robot 1.

Each of the light emitting modules 40 of the light emitting unit 750 may include at least one light source. For example, the light emitting modules 40 may include one or more light emitting diodes (LEDs), respectively.

Conventional analog lighting has a limitation in precisely controlling the illumination, but the light emitting diode (LED) can precisely control the illumination by adjusting the amount of applied current and the width of a driving pulse. In addition, when the light emitting diodes (LEDs) of R, G, and B colors are provided in combination, the light of a specific color can be provided and the adjustment of the color temperature can be easily accomplished.

The light emitting diode (LED) may be a single color light emitting diode (LED) such as Red, Blue, Green, and White. In some embodiments, the light emitting diode (LED) may be a multicolor light emitting diode (LED) for reproducing a plurality of colors.

In addition, the light emitting modules 40 may include a plurality of light emitting diodes (LEDs). All the plurality of light emitting diodes (LEDs) may emit white light to provide white lighting. Red, blue, and green light emitting diodes (LEDs) may be combined to provide illumination of a specific color or a white light.

For example, the light emitting modules 40 may output a first color (White) indicating a normal operation state, a second color (Yellow) indicating a pause state, and a third color (Red) indicating an error state.

The light emitting modules 40 may display the current operation state of the output light through colors and patterns, and may serve as a signal light for informing people of the traveling state and the operation state of the moving robot 1.

In addition, the controller 740 may control the light emitting unit 750.

For example, the controller 740 may control at least one of the light emitting modules 40 to output light of a certain color according to the current state of the moving robot 1. In addition, the controller 740 may control at least one of the light emitting modules 40 to blink in a certain cycle for a given time.

When the moving robot 1 moves (travels), even when a user approaches the moving robot 1 for information check, setting input, and other operation, or when a child touches the moving robot 1 with curiosity, if the moving robot 1 continues to travel, a safety accident such as a collision may occur.

Particularly, public places such as airport, railway station, terminal, department store, and mart have a large number of floating population, and there are many unexpected variables that lead to a higher risk of safety accidents.

Accordingly, when operating in a public place, the moving robot 1 according to the present invention outputs a light indicating the current operation state of the moving robot 1 through the light emitting unit 750, thereby providing signal information that allows people existing in a public place to easily recognize the current state of the moving robot 1. Accordingly, the possibility of an accident between a person and the moving robot 1 in a public place can be reduced.

Since the light emitting modules 40 are disposed apart from the second display 21 on the bottom cover 34 that is the lower end of the moving robot 1, they can be disposed in a position relatively lower than the eye level of the human and the second display 21. Accordingly, when the light emitting modules 40 continuously output or blink a specific light, people can feel less glare, and the output light of the light emitting modules 40 and the output image of the body display 21 can be prevented from deteriorating visibility of each other.

Preferably, the light emitting modules 40 may be disposed along the periphery of the bottom cover 34. The light emitting modules 40 are disposed to surround the bottom cover 34 in the horizontal direction so that people can see light emitted from the light emitting modules 40 in any direction of 360 degrees.

Meanwhile, the light emitting modules 40 may have a plurality of rows and may be disposed in multiple stages. Accordingly, visibility of light outputted by the light emitting modules 40 can be more enhanced.

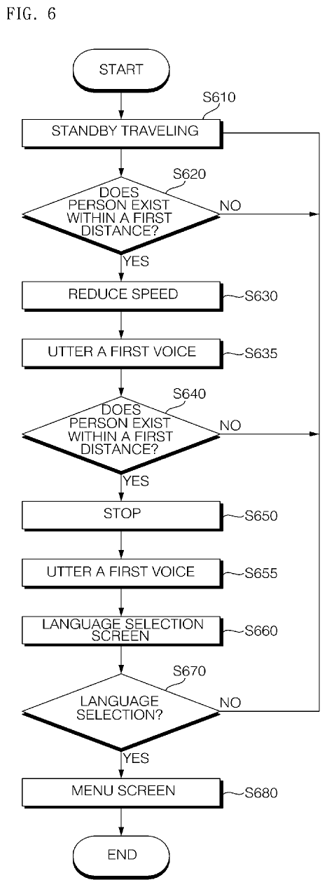

FIG. 6 is a flowchart illustrating an operation method of a moving robot according to an embodiment of the present invention.

The moving robot according to one embodiment of the present invention may identify a person or an obstacle, and determine a distance from the person or the obstacle.

The image acquisition unit 720 may include a vision sensor to recognize a person and an obstacle. For example, as described above with reference to FIGS. 1 to 4, the image acquisition unit 720 may include the head camera unit 313 for recognizing a person and an object, and the body camera unit 25 for identification and tracking of a guide target.

In addition, a person, an object, or the like may be detected by using a sensor provided in the sensor unit 770. For example, the sensor unit 770 may include the lidar 136, 118, the ultrasonic sensor 333, and the like.

The controller 740 may control the moving robot 1, based on detection data of the image acquisition unit 720 or the sensor unit 770.

In addition, the controller 740 may control the moving robot 1 by using the detection data of the image acquisition unit 720 and the sensor unit 770.

For example, the moving robot 1 may detect and track a person, an object, etc. by the lidar 136, 118 that can detect a relatively long range, and then may determine whether it is a person based on image data acquired by the image acquisition unit 720, and be operated accordingly.

Meanwhile, a plurality of reference distances may be preset, and the controller 740 may control the moving robot 1 based on whether a person is detected within a preset reference distance range.

For example, the reference distance in a first step may be set in correspondence with a sensing available distance of the lidar 136, 118, and the reference distance in a second step may be set in correspondence with a sensing available distance of the image acquisition unit 720.

However, since the sensing available distance of the lidar 136, 118 is quite large, it is preferable that a plurality of reference distances are set in detail according to other reference.

For example, the reference distance of the first step may be set in correspondence with the sensing available distance of the image acquisition unit 720, and the reference distance of second step may be set in correspondence with the interaction distance that allows the user to touch the moving robot 1 or to input a voice to the moving robot 1.

Accordingly, it is possible to determine whether a person exists at the reference distance of the first step, and to provide a detailed guide for providing a service at the reference distance of the second step.

Referring to FIG. 6, the controller 740 may determine whether a person exists within a preset first distance, based on the image data acquired by the image acquisition unit 720 (S620).

Meanwhile, in the present specification, the standby state means a state in which the moving robot 1 is ready to operate by receiving a command, and whether it is stopped is irrelevant.

For example, the moving robot 1 may stand by in a stop state in a certain position. The controller 740 may determine whether a person exists approaching within a first distance based on the moving robot 1 when the moving robot 1 is in a stop state.

In some embodiments, the moving robot 1 may stand by while traveling in a specified certain area or stand by in a specified pattern, until receiving a certain input from a specific user or performing a specific operation (S610). The standing by while the moving robot 1 travels in a specified certain area, or the standing by while traveling in a specified pattern may be referred to as a standby traveling.

It is preferable that the moving robot 1 which provides a guide service and the like in a public place does not stop in a fixed position in the standby state, but informs that the moving robot 1 is in operation while performing the standby traveling, and induces the use of the guide service.

As the moving robot 1 continues to move, it can stimulate people's curiosity and induce people to actively use the moving robot 1 or to interact with the moving robot 1.

The moving robot 1 according to an embodiment of the present invention may stand by while traveling in a specified certain area or stand by while traveling in a specified pattern (S610).

For example, the controller 740 may control the moving robot 1 to sequentially reciprocate a starting position and preset search positions, during the standby traveling (S610).

In some embodiments, the search positions may be set radially based on the starting position.

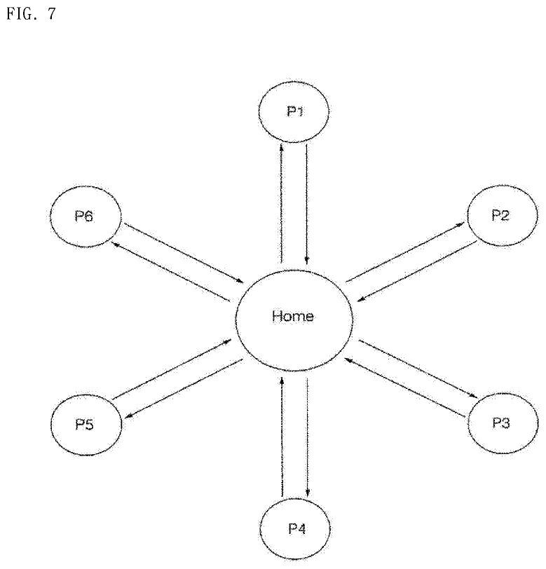

FIG. 7 is a view for explaining a standby traveling of a moving robot according to an embodiment of the present invention.

Referring to FIG. 7, the moving robot 1 may start standby traveling at the starting position (Home) or return to the starting position (Home) after the termination of the guide service.

Meanwhile, during standby traveling (S610), the moving robot 1 may sequentially reciprocates the search positions P1, P2, P3, P4, P5, and P6 radially disposed around the starting position (Home).

The moving robot 1 may return to the starting position (Home), after moving from the starting position (Home) to a first search position P1. Thereafter, the moving robot 1 may return to the starting position (Home), after moving from the starting position (Home) to a second search position P2. In this manner, the moving robot 1 may reciprocate the starting position and the preset search positions in the order of P1, P2, P3, P4, P5, P6.

The moving robot 1 may move again to the first search position P1, after returning from a sixth search position P6 to the starting position (Home).

Meanwhile, unlike FIG. 7, during standby traveling (S610), the controller 740 may control the moving robot 1 to move from the starting position (Home) to the first search position P1, and not to return to the starting position (Home).

For example, the moving robot 1 may move in the order of starting position (Home)-first search position P1-second search position P2-third search position P3-fourth search position P4-fifth search position P5-sixth search position P6-starting position (Home).

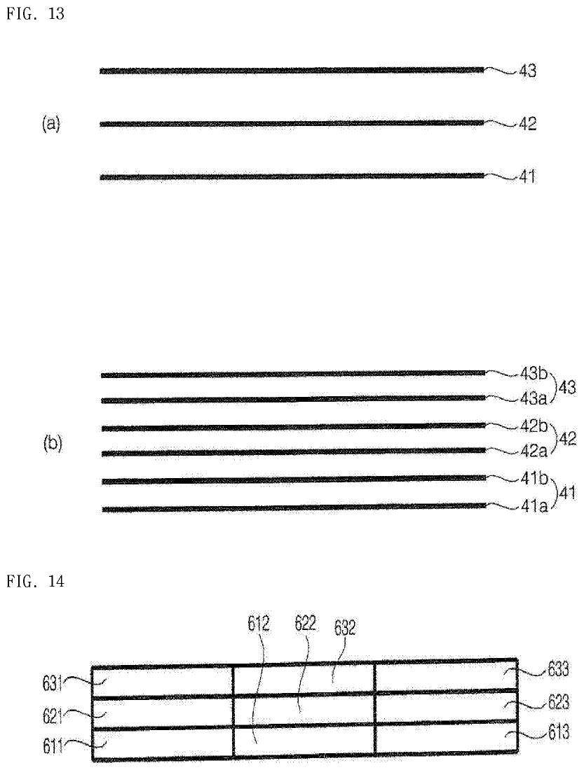

Meanwhile, in the moving robot 1 according to the embodiment of the present invention, the light emitting modules 40 may emit light, based on the current state of the moving robot 1. For example, when the moving robot 1 is in the standby traveling state S610, the controller 740 may control the light emitting modules 40 to emit light of a certain pattern corresponding to the standby traveling state S610. Light emitting based on the current state of the moving robot 1 will be described later in detail with reference to FIGS. 13 to 20.

Meanwhile, the moving robot 1 may recognize a guide target when a person approaches within a certain distance.

If a person exists within the first distance, the controller 740 may reduce the moving speed (S630).

A person existing within the first distance may be considered as a potential user who can use the guide service. Therefore, the moving robot 1 may decelerate so that the user can access the moving robot 1 more easily and safely.

In addition, if a person exists within the first distance from the moving robot 1 that is moving, there is a possibility of collision depending on the moving direction and speed of the moving robot 1 and the person. Therefore, the moving robot 1 may decelerate to prevent a safety accident.

In some embodiments, if a person exists within the first distance, the controller 740 may control the sound output unit 780 to utter a first voice guide containing greeting (S635). Accordingly, people may recognize the existence and approaching of the moving robot 1 and may know that the moving robot 1 is able to provide a service to the people.

In addition, when a person exists within the first distance, the controller 740 may control the top cover 31 to rotate so that one surface on which the operation unit 311 and the first display 312 are disposed faces the detected person.

That is, the controller 740 may rotate the head of the moving robot 1 so that one surface on which the operation unit 311 and the first display 312 are disposed faces the detected person. Accordingly, a user can intuitively know that the moving robot 1 has recognized user himself/herself and is ready to provide a service.

The moving robot 1 may recognize a guide target when a person approaches within a certain distance, and thus the top cover 31 may rotate.

Meanwhile, the controller 740 may determine whether a person exists within a second distance that is shorter than the first distance, based on the image data acquired by the image acquisition unit 720 (S640).

If a person exists within the second distance, the controller 740 may control the moving robot 1 to stop the movement (S650).

For example, if a person exists within the second distance which is the interaction distance, the controller 740 may control to terminate the standby traveling and stop.

Meanwhile, the controller 740 may display a screen for inducing a user's language selection (S660), and when receiving a language selection input through a user's touch input or voice input (S670), may display a main screen including plurality of main menu items (S680).

The language selection screen and the main screen that induce the language selection may be displayed on the first display 312 and/or the second display 21.

The controller 740 may display a screen through which user's touch operation can be achieved on the first display 312, and may control the second display 21 to display a detailed screen including detailed information related with the screen displayed on the first display 312 or a guide screen for inducing an operation through the first display 312.

For example, the controller 740 displays a main screen on which a certain item can be selected by a touch operation on the first display 312, and may control the second display 21 to display a guide screen for inducing an operation through the main screen displayed on the first display 312.

The controller 740 may recognize and process a voice input of a user inputted through the voice input unit 725.

In addition, the controller 740 may display the user's voice input guide information in a certain area of the main screen.

Meanwhile, the main screen may include category items in which guidable destinations are classified according to a certain criterion, and the main screen may differ depending on a location where the moving robot 1 is disposed.

According to an embodiment, if a person exists within the second distance, the controller 740 may control the sound output unit 780 to utter a second voice guide for inducing language selection (S655). Accordingly, people may select a use language by touch or voice, and may easily know which input can select a language.

Meanwhile, before displaying the language selection screen (S660), the controller 740 may control at least one of the displays 312 and 20 to face the detected user so that the user may easily view the screen.

After the stop S650, the controller 740 may control the top cover 31 to rotate so that one surface on which the operation unit 311 and the first display 312 are disposed faces the person detected within the second distance.

That is, the controller 740 rotates the head of the moving robot 1 so that one surface on which the operation unit 311 and the first display 312 are disposed faces the detected person. Thus, people can intuitively know that the moving robot 1 is ready to speak to people themselves and provide a service.

Alternatively, after the stop (S650), the controller 740 may control the main body 10 to rotate in place so that the second display 21 having a larger size than the first display 312 faces the person detected within the second distance.

Alternatively, after stopping (S650), the controller 740 may rotate the main body 10 so that the second display 21 having a size larger than the first display 312 faces the person detected within the second distance, and then control the first display 312 and the second display 21 to face a specific person, by rotating the head of the moving robot 1 so that one surface on which the operation unit 311 and the first display 312 are disposed faces the detected person.

Meanwhile, many people may exist in a certain space in a public place. Therefore, when a plurality of people are detected simultaneously or within a given time, a target user for whom the moving robot 1 moves/stops or the screen is displayed should be selected.

According to an embodiment of the present invention, when a plurality of people exist within the second distance, the moving robot 1 may rotate to face a person selected based on a distance and an angle with respect to the moving robot 1. Accordingly, when approaching a plurality of people, a guide target may be recognized based on the distance and the angle with respect to the moving robot 1.

For example, if a plurality of people exist within the second distance, the controller 740 may control to rotate toward the person located in the shortest distance based on the moving robot 1.

Here, the controller 740 may control the moving robot 1 so that at least the first display 312 faces the person closest to the moving robot 1.

The controller 740 may rotate the top cover 31 so that the first display 312 faces the person closest to the moving robot 1.

Alternatively, the controller 740 may rotate the main body 10 so that the second display 21 faces the person closest to the moving robot 1, and then may rotate the top cover 31 so that the first display 312 faces the same person.

According to an embodiment, when a plurality of people exist within the second distance, the controller 740 may control to rotate toward the person closest to the traveling direction of the moving robot 1.

The controller 740 may rotate the top cover 31 so that the first display 312 faces the person closest to the front of the moving direction of the moving robot 1.

Alternatively, the controller 740 may rotate the main body 10 so that the second display 21 faces the person close to the front of the moving direction of the moving robot 1, and then may rotate the top cover 31 so that the first display 312 faces the same person.

If there is no person in the front of the traveling direction of the moving robot 1 among the plurality of detected people, a person located in the side of the traveling direction is selected, and if no person is located in the front and the side, the person located in the back of the traveling direction may be selected.

In addition, when selecting a person located in the side or the back, a person located in the smallest angle range based on the traveling direction may be selected. That is, a person located at an angle range capable of performing the least rotation from the front of the driving direction may be selected.

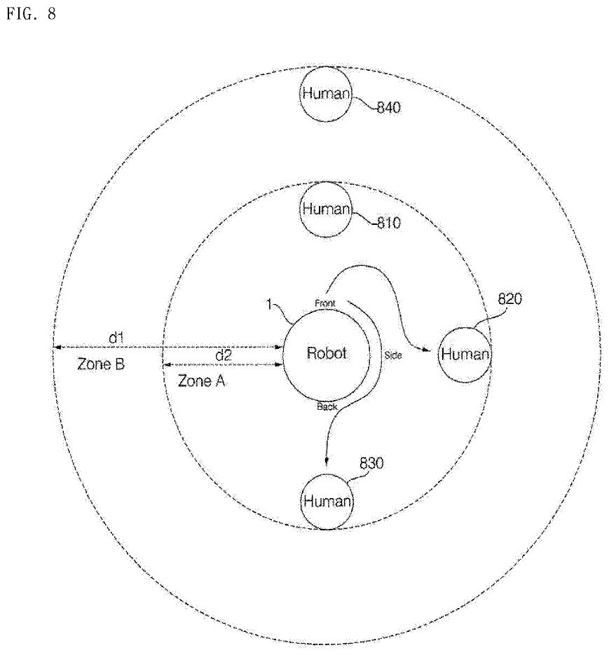

FIG. 8 is a view for explaining a user detection distance of a moving robot and an operation for each zone according to an embodiment of the present invention.

In a public place where many people exist, the moving robot 1, which provides information, guide service, and the like through interaction with people, requires a priority on which user is targeted for service provision, and a feedback priority on many situations.

According to an embodiment of the present invention, the area around the moving robot 1 may be divided into several zones based on the distance, and the distance and the angle with respect to a target that is close to the moving robot 1 above a certain level may be determined.

Referring to FIG. 8, a first zone B corresponding to the first distance d1 or less around the moving robot 1 and a second zone A corresponding to the second distance d2 or less around the moving robot 1 may be set.

According to an embodiment of the present invention, when it is determined that a target detected within the first distance d1 is a person who becomes closer to the direction of the moving robot 1, the moving robot 1 may move and rotate to face the person in order to induce the use of the mobile robot 1.

When a person comes closer to the moving robot 1 and enters within the second distance d2, it may be determined that there is an intention to use the moving robot 1, and a specific function and a service may be provided.

According to an embodiment of the present invention, rather than interacting with everyone, a person who approaches the moving robot 1 has a high interaction priority.

In addition, when there are a large number of people 810 and 840 approaching the moving robot 1, the closest person 810 has a higher priority. Alternatively, when there are a large number of people 810 and 840 approaching the moving robot 1, the priority of the person 810 approaching from the front of the moving robot 1 may be set higher. In this case, the priority may be set in the order of the front, side, and back of the moving robot 1.

When a plurality of people exist in the second zone A,

the moving robot 1 may rotate in place to face a person selected based on a distance and an angle from among the plurality of people, after stopping.

For example, the controller 740 may control the moving robot 1 so that at least the first display 312 faces the person closest to the moving robot 1.

The controller 740 may rotate the top cover 31 so that the first display 312 faces the person closest to the moving robot 1.

Alternatively, the controller 740 may rotate the main body 10 so that the second display 21 faces the person closest to the moving robot 1, and then rotate the cover 31 so that the first display 312 may face the same person.

In some embodiments, the controller 740 may rotate the top cover 31 so that the first display 312 faces the person closest to the front of the moving direction of the moving robot 1.

Alternatively, the controller 740 may rotate the main body 10 so that the second display 21 faces the person close to the front of the moving direction of the moving robot 1, and then may rotate the top cover 31 so that the first display 312 faces the same person.

The controller 740 may select any one of a plurality of persons according to the priority set in the order of front, side, and back.

Accordingly, without adding a separate configuration to the moving robot 1, it is possible to autonomously determine the interacting target, and it is possible to actively provide more use opportunities to users in a public place.

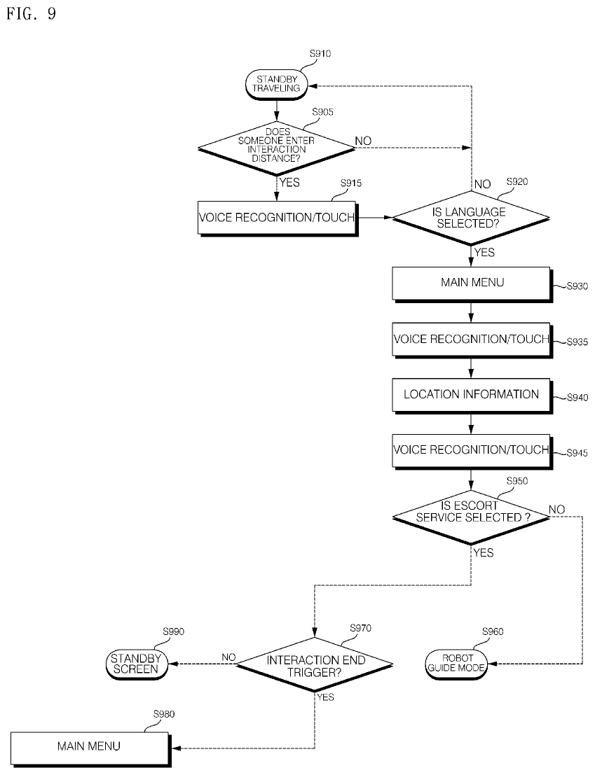

FIG. 9 is a flowchart illustrating a method of operating a moving robot according to an embodiment of the present invention, and illustrates a process of entering a robot guide mode in which the moving robot 1 moves and guides a user to a certain destination in a standby state.

Referring to FIG. 9, the moving robot 1 may display a standby screen on the second display 21 (S910), while detecting whether a person approaches in a standby state (S905).

The detection of approach of a person may be performed by the sensor unit 770 including an obstacle detection sensor such as the ultrasonic sensor 333, the RGBD sensor 321, the lidar 132a, 132b, and the like.

In addition, the approach of a person within a certain distance may be determined based on the image acquired by the image acquisition unit 720 including the head camera unit 313 and the body camera unit 25.

In addition, the controller 740 combines the data acquired by the sensor unit 770 and the image acquisition unit 720, so that the presence of a person approaching the moving robot 1, the distance between the person and the moving robot 1, and the like can be determined.

The controller 740 may determine which person enters within a preset interaction distance range (S905). The interaction distance range may be set based on the distance in which the moving robot 1 can receive a touch input or a voice input from a user who will use a service. The interaction distance range may be set based on the distance in which the moving robot 1 can receive a touch input or a voice input from a user who will use the service.

Here, the interaction distance range may correspond to the second distance and the second zone A described with reference to FIGS. 6 to 8.

In addition, when there are a plurality of people within the interaction distance range, one person may be selected according to a preset priority, and interaction may be started based on the selected one person.

Meanwhile, when a user is detected within a preset interaction distance range (S905), the controller 740 may control the first display 312 to display a main screen including a plurality of menu items (S930).

That is, the controller 740 may control the second display 21 to display a standby screen when there is no person within a certain distance, and control the first display 312 to display a main screen including a plurality of main menu items when a person exists within a certain distance.

In addition, the controller 740 may control the first display 312 or the second display 21 to display certain information based on the distance from the user.

According to the present invention, it is possible to switch the screen between the displays 312 and 21 according to the amount of information, and the information displayed on the displays 312 and 21 may be displayed by dividing context related information.

The user may search a place in the airport by the first display 312 located at a touchable distance near the moving robot 1. The moving robot 1 may show the result in association with the large second display 21 according to the amount of information when providing the search result.

According to the present invention, a display suitable for the interaction distance between the moving robot and the user may be selected and used.

For example, when the distance between the moving robot 1 and the user is far, certain information is displayed on the second display 21, which is a large screen, and when the distance is short, certain information is displayed on the first display 312.

In addition, the user may operate by touch and voice recognition during interaction at a distance close to the moving robot 1, and brief information may be displayed on the first display 312.

In addition, when the user interacts with the moving robot 1 at a long distance, the user may operate the moving robot 1 by a gesture and voice recognition, and may provide specific information by using the second display 21 configured as a large screen.

Meanwhile, since a public place such as airport may be used by people of various nationalities, there are various types of languages used by people.

Therefore, before displaying the main screen including a plurality of main menu items (S930), when displaying a screen for inducing the user's language selection, and recognizing the user's touch input or voice input (S915), and when the language selection is accomplished (S920), a main screen including the plurality of main menu items may be displayed (S930).

Meanwhile, the controller 740 may control the first display 312 to display a screen on which the user's touch operation can be accomplished, and control the second display 21 to display a detail screen including detailed information associated with a screen displayed on the first display 312 or a guide screen for inducing an operation through the first display 312.

For example, the controller 740 may display a main screen on which a certain item can be selected by a touch operation on the first display 312, and may control the second display 21 to display a guide screen for inducing an operation through the main screen displayed on the first display 312.

Meanwhile, the controller 740 may recognize and process the voice input of user inputted through the voice input unit 725.

In addition, the controller 740 may display user's voice input guide information in a certain area of the main screen.

Meanwhile, the main screen may include category items in which guidable destinations are classified according to a certain criterion, and the main screen may also vary according to the location where the moving robot 1 is disposed.

Thereafter, when the user inputs a certain keyword by voice input or touch input (S935), the controller 740 may provide a screen for guiding location information of a destination corresponding to the keyword (S940).

The screen for guiding the location information of the destination may be provided through at least one of the first display 312 or the second display 21.

For example, a screen for guiding location information of a destination may be displayed on the first display 312 or the second display 21.

Meanwhile, when a destination is inputted by voice input or touch input, a destination list, a location on map, a current location, and the like may be displayed on the first display 312, and an entire airport map, a route, a distance, and an estimated time to arrive may be displayed on the second display 21.

In addition, when a destination is inputted by inputting a ticket, simplified information may be displayed on the first display 312, and a large image and detailed information may be displayed on the second display 21.

In addition, when the guide destination input is received by voice input or touch input, the controller 740 may control the second display 21 to display a detailed screen for the inputted guide destination, and may control the first display 312 to display a menu item for requesting a guide service (escort service) for moving and guiding to the inputted guide destination, and a guide message for inducing the check of the destination displayed on the second display 21.

That is, the first display 312 may display a screen including a menu item and brief information for requesting a guide service by a touch input, and the second display 21 may display a map screen including a guide destination and a detailed screen including detailed information including a name, a location, a distance, etc. of the guide destination.

Meanwhile, the controller 740 may control to perform an operation corresponding to the voice input or the touch input (S945) of user which is received while a screen for guiding the location information of the destination is displayed.

For example, if the user requests an escort service (S950), the controller 740 may control to enter a robot guide mode in which the moving robot 1 guides while moving to the guide destination (S960).

In addition, if there is no input for a given time (S970), the controller 740 may control the standby screen to be displayed on the second display 21 again (S990).

In addition, when the user checks and closes a screen for guiding the location information of the destination, the controller 740 may control the first display 312 to display the main screen including the main menu items again so that other menu can be selected (S980).

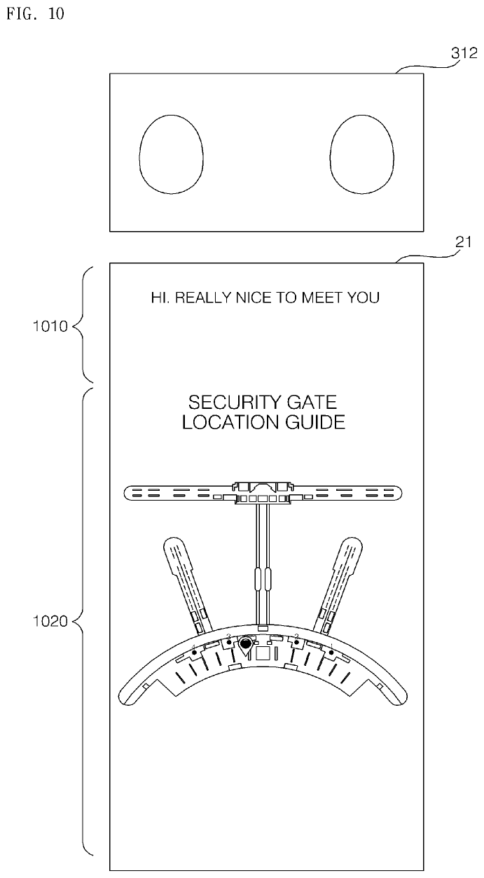

FIGS. 10 to 12 are views for explaining an operation method of a moving robot according to an embodiment of the present invention.

FIG. 10 illustrates a standby screen or a screen displayed during the utterance of a first voice guide.

Referring to FIG. 10, the moving robot 1, which is in a standby state, may display an image representing an expression corresponding to the standby state on the first display 312.

Referring to FIG. 10, the moving robot 1, which is in a standby state, may sequentially display greeting such as ‘Hi. I'm so glad to see you’ and the explanation of guide function on a use guide area 1010 of the second display 21.

The greeting and explanation may be provided in many languages. For example, ‘ [symbol] ’, ‘Have a nice trip’ may be displayed alternately.

In addition, various descriptions such as ‘ [symbol] [symbol] ’, ‘Have a great day’, ‘ [symbol] ’, ‘Have a comfortable trip’, ‘ [symbol] . [symbol] [symbol] .’, ‘Hello. My name is Airstar’ may be used as the above greeting.

In addition, ‘ [symbol] [symbol] [symbol] ’, ‘I can direct you to locations in the airport’, ‘ [symbol] [symbol] ’, ‘Hello. Ask me a question’ may be used as the description of the above guide function.

In addition, the greeting and explanation may be provided in Chinese, Japanese, and French as well as Korean and English.

Meanwhile, the moving robot 1 in the standby state may display a guide screen of preset destinations in an information area 1020 of the second display 21.

For example, the guide screen displayed on the information area 1020 may include a map including location information of a security gate, a counter, and a door.

In addition, maps including location information of the security gate, the counter, and the door may be sequentially displayed in the information area 1020.

Meanwhile, the moving robot 1 may display different standby screens according to the characteristics of the disposed place in the airport.

If a user is detected within a preset interaction distance range, the controller 740 may control the first display 312 to display a screen for inducing a language selection of the user.

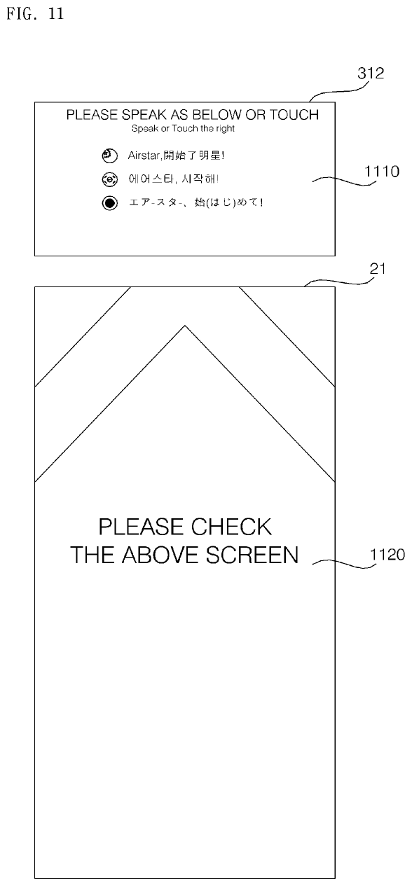

FIG. 11 illustrates a language selection screen.

Referring to FIG. 11, text written in other language having the same meaning as Korean text such as ‘ [symbol] , [symbol] ’ may be displayed on the first display 312.

In addition, the second display 21 may display a screen 142 for inducing the operation of the first display 312.

When a user selects a text corresponding to the language used by the user from among the displayed texts, the controller 740 may provide a service in a language corresponding to the selected text.

Alternatively, when the user utters a voice input such as ‘Airstar, start,’ the controller 740 may recognize the type of language uttered by the user and provide a service in the recognized language.

Meanwhile, after selecting the language, the moving robot 1 may display a main screen including a plurality of main menu items on the first display 312.

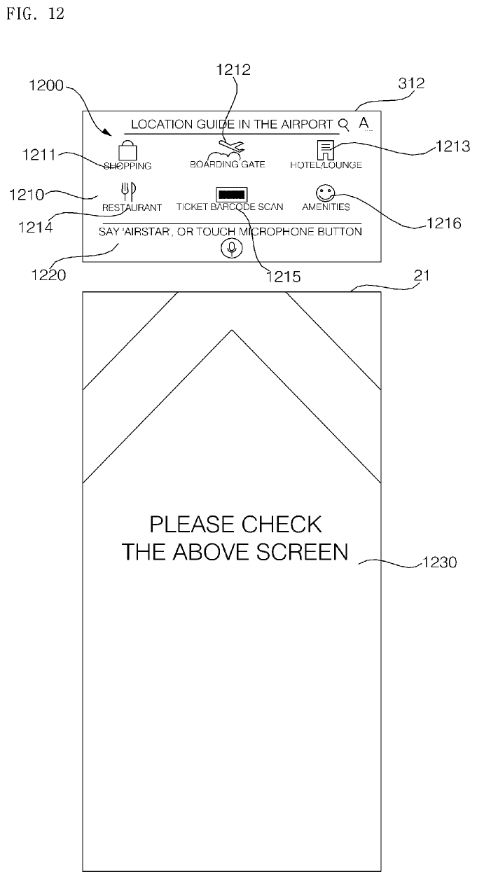

FIG. 12 illustrates main screens, and FIG. 12 illustrates a main screen displayed by a moving robot disposed in an air side in an airport.

Referring to FIG. 12, a main screen 1200 displayed in the first display 312 of the moving robot disposed in the air side may include a main menu area 1210 and a voice recognition area 1220.

The main menu area 1210 may include main menu items configured of category items in which destinations are classified according to a certain criterion.

For example, the main menu items may include shopping 1211, boarding gate 1212, hotel/lounge 1213, restaurant 1214, ticket barcode scan 1215, and amenities 1216.

The user may elect any one of the shopping 1211, the boarding gate 1212, the hotel/lounge 1213, the restaurant 1214, the ticket barcode scan 1215, and the amenities 1216 by the voice or touch input. Then, a destination included in a corresponding category may be found or a corresponding service may be provided.

In a voice recognition area 1220, a voice recognition microphone button and a call word guide may be displayed. For example, when ‘Air star’ is set as a call word, a call word induce guide to call ‘Air star’ or to touch a microphone button may be displayed.

The controller 740 may control to enter a voice recognition process when the user touches the microphone button of the voice recognition area 1220 or utters a call word.

Meanwhile, a screen 1530 for inducing the operation of the first display 312 may be displayed on the second display 21.

FIGS. 13 to 20 are views for explaining an operation method of a moving robot according to an embodiment of the present invention.

Referring to FIG. 13A, the light emitting modules 40 may be disposed in three stages along the circumference of the bottom cover 34. That is, the light emitting modules 40 may be disposed to form three rows 41, 42, and 43.

The plurality of light emitting modules 40 disposed in rows 41, 42, and 43 may be controlled in a unit of row. In addition, the plurality of light emitting modules 40 included in any one of the rows 41, 42, and 43 may be group controlled in a certain number unit within the same row. Obviously, it can be controlled in an individual unit.

Meanwhile, in some embodiments, one row 41, 42, 43 may include a plurality of lines controlled together. For example, each row 41, 42, 43 may include a pair of lines that can be controlled together, and each line may include a plurality of light emitting modules.

Referring to FIG. 13B, a first row 41 may include a pair of lines 41a and 41b, a second row 42 may include a pair of lines 42a and 42b, and a third row 43 may include a pair of lines 43a and 43b. Even in this case, a plurality of light emitting modules may be disposed along each line 41a, 41b.

Meanwhile, when the entire first row 41 is controlled to be turned on, the entire light emitting modules of the line 41a, 41b may be turned on. In addition, when any one light emitting module of the first line 41a of the first row 41 is turned on, a corresponding light emitting module of the second line 41b of the first row 41 is turned on, so that control may be achieved in pairs.

The bottom cover 34 may have a cylindrical shape having a diameter that decreases as it progresses downward from the top to the bottom so as to prevent the human foot from being caught in the bottom of the moving robot 1, or in the wheel.

In correspondence with the shape of the bottom cover 34, the light emitting modules 40 may be disposed in three rows 41, 42, and 43 having different lengths. In this case, the length of the row 41 located at the lowermost end of the three rows 41, 42, 43 may be the shortest.

More preferably, the light emitting modules 40 may be disposed to have a plurality of rows and columns. For example, the light emitting modules 40 may be disposed in three rows 41, 42, and 43, and each row 41, 42, 43 may include a plurality of light emitting modules that are independently controllable.

Accordingly, the light emitting modules 40 may be disposed to have a plurality of rows and columns, and when the entire light emitting modules 40 are unfolded, they may be disposed in the form of a matrix type of M*N.

FIGS. 13 to 20 illustrate an example in which the light emitting modules 40 are disposed in the form of a matrix type of 3*3, and the number of rows and columns is exemplary.

In addition, FIGS. 13 to 20 illustrate an example in which the lengths of the rows 41, 42, and 43 formed of the light emitting modules 40 are the same, but the present invention is not limited thereto.

Referring to FIGS. 13 to 20, first to third light emitting modules 611, 612, and 613 may be disposed in the first row 41 positioned in the lowermost end.

In addition, fourth to sixth light emitting modules 621, 622, and 623 may be disposed in the second row 42 positioned in the upper end of the first row 41, and seventh to ninth light emitting modules 631, 632, and 633 may be disposed in the third row 43 positioned in the upper end of the second row 41.

In some embodiments, the light emitting modules 611, 612, 613, 621, 622, 623, 631, 632, and 633 may be disposed to be adjacent to the row and spaced apart from the column.

For example, as shown in FIG. 13, the first row 41 and the second row 42, and the second row 42 and the third row 43 may be formed to be spaced at a certain distance apart. Alternatively, the first row 41 and the second row 42, the second row 42 and the third row 43 may be adjacent to each other.

In addition, as shown in FIGS. 14 to 20, the light emitting modules included in the same row may be disposed to be adjacent to each other one by one. In this case, unlike FIGS. 14 to 20, the light emitting modules included in the same row may be disposed to be spaced apart from each other.

Meanwhile, the controller 740 may control the operation of all the light emitting modules 611, 612, 613, 621, 622, 623, 631, 632, and 633.

The controller 740 may control the light emitting modules 611, 612, 613, 621, 622, 623, 631, 632, and 633 in a unit of individual light emitting module.

For example, the controller 740 may control to sequentially turn on from the first light emitting module 611 disposed in the first row and the first column to the ninth light emitting module 633 disposed in the third row and the third column.

In addition, the controller 740 may control all the light emitting modules 611, 612, 613, 621, 622, 623, 631, 632, 633 to output light of the same color, or control some light emitting modules to output light of a color different from the other light emitting module.

In addition, the controller 740 may control all the light emitting modules 611, 612, 613, 621, 622, 623, 631, 632, and 633 to be turned on or control only specific light emitting modules to be turned on.

FIG. 14 illustrates a case in which all the light emitting modules 611, 612, 613, 621, 622, 623, 631, 632, and 633 are turned on to output white light.

The controller 740 may control all the light emitting modules 611, 612, 613, 621, 622, 623, 631, 632, and 633 to be turned on to output white light, when the moving robot 1 is in an interaction state with a certain user.

The interaction state may correspond to a case in which the moving robot 1 provides a voice guide, a menu screen, or the like to a certain user, receives a touch, a voice input from a user, or is providing a guide service.

In addition, the controller 740 may control the light emitting modules 611, 612, 613, 621, 622, 623, 631, 632, and 633 in a row unit or in a column unit. Accordingly, people may see a light emitting pattern more easily than when an individual light emitting module emits light.

For example, the light emitting module may be turned on in the order of the first row, second row, and third row of lowermmost end.

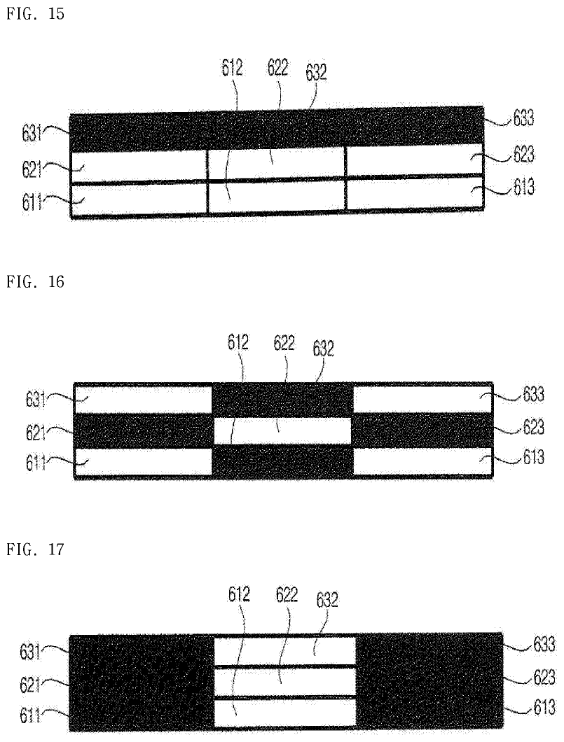

FIG. 15 illustrates a state where the fourth to sixth light emitting modules 621, 622, and 623 disposed in the second row 42 are turned on to output white light after the first to third light emitting modules 611, 612, and 613 disposed in the first row 41 are turned on.

When a given time elapses after the fourth to sixth light emitting modules 621, 622, and 623 disposed in the second row 42 are turned on, the seventh to ninth light emitting modules 631, 632, and 633 disposed in the third row 43 will be turned on to output white light.

In addition, when all of the light emitting modules 611, 612, 613, 621, 622, 623, 631, 632, 633 are turned on and a given time elapses, the controller 740 may control all the light emitting modules 611, 612, 613, 621, 622, 623, 631, 632, 633 to be turned off together.

That is, the controller 740 may control the light emitting modules 611, 612, 613, 621, 622, 623, 631, 632, and 633 to be sequentially turned on, and then, to be simultaneously turned off. On the other hand, the light emitting modules 611, 612, 613, 621, 622, 623, 631, 632, and 633 may be controlled to be simultaneously turned on, and then, to be sequentially turned off.

When the moving robot 1 is in a standby state, the controller 740 may control the light emitting modules 611, 612, 613, 621, 622, 623, 631, 632, and 633 to be turned on sequentially in a row unit, as shown in FIG. 15. Thereafter, the controller 740 may control the light emitting modules 611, 612, 613, 621, 622, 623, 631, 632, and 633 to be simultaneously turned off or sequentially turned off.

Meanwhile, in the present specification, the standby state means a state in which the moving robot 1 is ready to operate by receiving a command, and whether it is stopped is irrelevant.

For example, the moving robot 1 may stand by in a stop state in a certain position. In some embodiments, the moving robot 1 may stand by in the traveling state in a specified certain area or may stand by in a specified pattern, until receiving a certain input from a specific user or performing a specific operation.

Meanwhile, the controller 740 may control a certain light emitting module to be turned on and off, when a specific situation occurs that requires attention other than stop and pause, or to be turned on and off in a random pattern or a pattern set in correspondence with the specific situation.

For example, referring to FIG. 16, the controller 740 may control specific light emitting modules 611, 613, 622, 631, 633 of the light emitting modules 611, 612, 613, 621, 622, 623, 631, 632, 633 to be turned on to output white light.

When the moving robot 1 is traveling forward or is turning, the controller 740 may control the light emitting modules 611, 612, 613, 621, 622, 623, 631, 632, and 633 to be sequentially turned on and then turned off in the unit of row.

In addition, when the moving robot 1 is traveling forward or is turning, the controller 740 may control the light emitting modules 611, 612, 613, 621, 622, 623, 631, 632, and 633 to be turned on and turned off, based on the traveling direction.

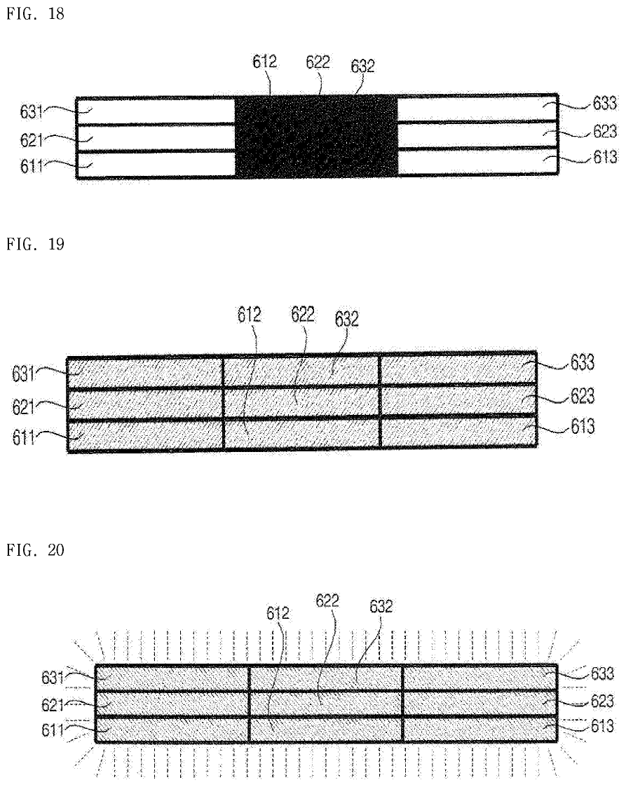

Referring to FIGS. 17 and 18, when the moving robot 1 is traveling forward, after turning on the light emitting modules 612, 622, 632 disposed in a specific column, depending on the forward or backward direction, the controller 740 may turn on the light emitting modules 611, 621, and 631 disposed in the front column or the light emitting module disposed in the rear column 613, 623, and 633.

In some embodiments, when traveling forward, the light emitting module may be turned on in the order of the first row, the second row, and the third row of lowermost end. When traveling backward, the light emitting module may be turned on in the order of the third row, the second row, and the first row of uppermost end.

In addition, when the moving robot 1 is turning, after turning on the light emitting module 612, 622, 632 disposed in a specific column, depending on the turning direction, the controller 740 may adjust the heat of the light emitting module which is turned on and off clockwise or counterclockwise.

When the moving robot 1 is turning, after turning on the light emitting module 612, 622, 632 disposed in a specific column, the controller 740 may adjust the heat of the light emitting module which is turned on and off in the same direction as the turning direction.

In this case, the plurality of light emitting diodes included in a single light emitting module may also be sequentially turned on and off in a clockwise or counterclockwise direction.

Meanwhile, if the moving robot 1 is in a stopped state or a pause state, the controller 740 may control all of the light emitting modules 611, 612, 613, 621, 622, 623, 631, 632, 633 to output light of a certain color.

In the present specification, the stopped state may mean a state in which the moving robot 1 is stopped, when the guide service for the user is terminated or when the user who used the guide service is not detected for a certain time or more.

In addition, the pause state may mean a state in which the moving robot 1 temporarily stops to avoid a person or an obstacle and resumes movement, after a certain time elapses or when a person or an obstacle is not detected.

Referring to FIG. 19, when the moving robot 1 is in a stopped state, the controller 740 may control all of the light emitting modules 611, 612, 613, 621, 622, 623, 631, 632, and 633 to output a red light.

In addition, referring to FIG. 20, when the moving robot 1 is in a pause state, the controller 740 may control all of the light emitting modules 611, 612, 613, 621, 622, 623, 631, 632, and 633 to repeat the on/off state for a short time and output white light or yellow light.

In addition, as the distance between the person and the moving robot 1 becomes closer or the current situation becomes dangerous, the flickering cycle may be set shorter.

According to the present invention, the moving robot 1 may be provided with a plurality of light emitting modules for intuitive and easy interaction with people living in various environments.

In addition, by controlling the plurality of light emitting modules to be turned on or off according to the operation state of the moving robot 1, it is possible to inform the state of the moving robot in order to prevent a collision with a person during traveling, and even during a stop, to inform the robot's current state such as a failure, interaction with user, and work processing.

The moving robot 1 according to an embodiment of the present invention may inform other surrounding people of the stopping or traveling state of the robot by adjusting the flickering order, timing, and the like of the light emitting module.

According to at least one of the embodiments of the present invention, it is possible to provide various services, such as a guide service in a public place.

In addition, according to at least one of the embodiments of the present invention, it is possible to easily provide information displayed on a display in the process of providing a service such as a road guide.

In addition, according to at least one of the embodiments of the present invention, it is possible to improve the efficiency and user convenience of the information providing method by utilizing two displays in various manners depending on the type of information, the amount of information, the interaction distance between the robot and the user, and the size of the display.

In addition, according to at least one of the embodiments of the present invention, it is possible to provide a moving robot that can be safely operated in a public place and an operation method of the same.

In addition, according to at least one of the embodiments of the present invention, it is possible to provide a moving robot and an operation method of the same that can reduce the risk of accidents of people and the moving robot by allowing people to easily determine the traveling state of the moving robot.

The moving robot according to the present invention is not limited to the configuration and method of the embodiments described above, but the above embodiments may be configured by selectively combining all or some of the embodiments so that various modifications can be achieved.

Meanwhile, the operation method of the moving robot according to the embodiment of the present invention can be implemented as a code readable by a processor on a recording medium readable by the processor. The processor-readable recording medium includes all kinds of recording apparatuses in which data that can be read by the processor is stored. Examples of the recording medium that can be read by the processor include a ROM, a RAM, a CD-ROM, a magnetic tape, a floppy disk, an optical data storage apparatus, and the like, and may also be implemented in the form of a carrier wave such as transmission over the Internet. In addition, the processor-readable recording medium may be distributed over network-connected computer systems so that code readable by the processor in a distributed fashion can be stored and executed.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

1-20. (canceled)

21. A method of operating a moving robot, the method comprising:
determining whether a person exists within a preset first distance;
reducing a movement speed, when a person exists within the first distance;
uttering a first voice guide including a greeting, when a person exists within the first distance;
determining whether a person exists within a second distance set to be shorter than the first distance;
stopping a movement, when a person exists within the second distance;
rotating a top cover so that one surface on which an operation unit and a first display are disposed faces a person detected within the second distance, after the stopping.
rotating a main body in place so that a second display having a larger size than the first display faces the person detected within the second distance, after the stopping.
receiving a language selection input; and
displaying a menu screen based on a language corresponding to the language selection input.

22. The method of claim 21, wherein rotating the main body comprises rotating toward a person located in a shortest distance based on the moving robot, when a plurality of persons exist within the second distance.

23. The method of claim 21, wherein rotating the main body comprises rotating toward a person located closest to a traveling direction of the moving robot, when a plurality of persons exist within the second distance.

24. The method of claim 21, wherein rotating the main body comprises rotating toward a person selected based on a distance and an angle with respect to the moving robot, when a plurality of persons exist within the second distance.

25. The method of claim 21, further comprising:
uttering a second voice guide for inducing language selection, when a person exists within the second distance.

26. The method of claim 21, further comprising performing a standby traveling that sequentially reciprocates a starting position and preset search positions.

27. The method of claim 26, wherein the search positions are set radially based on the starting position.

28. The method of claim 21, wherein the language selection input is received by a voice input or a touch input.

29-39. (canceled)
